(19) United States
(12) Patent Application Publication
(10) Pub. No.: US 2019/0032258 A1
(43) Pub. Date: Jan. 31, 2019

(54) INFILTRATION AND RINSE DEVICE OF CONVEYOR-DRIVEN FABRIC DYEING MACHINE

(71) Applicant: CHI-LUNG CHANG, Taoyuan City (TW)

(72) Inventor: CHI-LUNG CHANG, Taoyuan City (TW)

(21) Appl. No.: 15/905,842

(22) Filed: Feb. 27, 2018

(30) Foreign Application Priority Data
Jul. 28, 2017 (TW) 106211115

(51) Int. Cl. D06B 1/02; B05B 16/00; B08B 3/02

(52) U.S. Cl. CPC D06B 1/02; D06B 2700/36; B08B 3/022; B05B 16/90

(57) ABSTRACT

A conveyor-driven fabric dyeing machine includes an infiltration and rinse device. Fabric is driven by a conveyor inside a machine body of the dyeing machine and has an extremely low liquid content rate due to separation of fabric, particularly hydrophobic fabric, and liquid. The fabric might get rubbed and damaged and affected in respect of dyeing homogeneity and reduction and cleaning. Quality of the fabric may also be affected by contaminants present inside the machine body. The infiltration and rinse device includes one or multiple spraying devices mounted inside the machine body at a suitable site to receive and jet and spray a pressurized dye liquid or clear water supplied from a pump onto the fabric or the interior space of the machine body to increase a moisten degree of the fabric and also to rinse the fabric and cleanse the interior of the machine body.

### (a) TECHNICAL FIELD OF THE INVENTION

The present invention relates to a dyeing machine that comprises a conveyor for conveying and moving fabric, and in particular to a dyeing machine that sprays, through spraying devices, pressurized dye liquid or clean water supplied from an outlet terminal of a pump to fabric or interior of a machine body thereof during the movement of the fabric in order to enhance the moistening degree of the fabric and also to rinse the fabric and remove contamination and staining deposited in the interior of the machine body.

### (b) DESCRIPTION OF THE PRIOR ART

A conveyor-driven dyeing machine in which fabric is driven by a conveyor to circulate and cyclically move in a machine body of a dyeing machine in order to be dyed is different from another known type of dyeing machine that involves a great amount of dye liquid deposited in a machine body so that fabric is supported by buoyance thereof to float inside the machine body for circulation and cyclically moving. In the conveyor-driven dyeing machine, fabric is positioned on the conveyor for being moved cyclically and in such a condition, the fabric absorbs and contains therein an extremely low amount of water or liquid and this might cause inhomogeneous dyeing of the fabric. Further, minute cotton pieces or chips or other impurities and debris that are carried by the fabric or staining or contamination inside the machine body may causes undesired influence on the quality of the fabric so dyed.

### SUMMARY OF THE INVENTION

The objective of the present invention is to overcome drawbacks that fabric, particularly hydrophobic fabric, that is driven by a conveyor may undergo separation of fabric from liquid or water, leading to extremely low content rate of water or liquid therein, so that the fabric may be rubbed and damaged or affected in respect of homogeneity of dyeing and reduction and cleaning thereof, or surface quality of the fabric may be affected as being stained by contamination present inside the machine body. The present invention proposes an arrangement of one or multiple spraying devices mounted at a predetermined location inside the machine body in order to jet and spray a pressurized dye liquid or clear water, which is supplied from an outlet terminal of a pump, onto the fabric and also the interior of the machine body in order to increase a moistening degree of the fabric and also to rinse the fabric and remove contamination from the interior of the machine body.

The feature of the present invention is that a fabric dyeing machine comprises a machine body in which one or multiple spraying devices are mounted such that an end of the spraying device is connected to an outlet terminal of a pump in order to jet and spray a pressurized dye liquid or clear water supplied from the pump onto fabric carried on and cyclically moved by a conveyor to increase a moistening degree of the fabric and also to clean up minute cotton pieces and chips or impurities attached to the fabric and also contaminants present in the interior of the machine body.

One technical solution of the present invention is that a machine body of a fabric dyeing machine is provided with one or multiple spraying devices, wherein the spraying device has an end that is connected to an outlet terminal of a pump in order to receive and jet and spray a pressurized dye liquid or clear water supplied from the pump onto fabric carried on and cyclically moved by a conveyor to increase a moistening degree of the fabric and also to clean up minute cotton pieces and chips or impurities attached to the fabric and also contaminants present in the interior of the machine body.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of a dyeing machine according to an embodiment the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

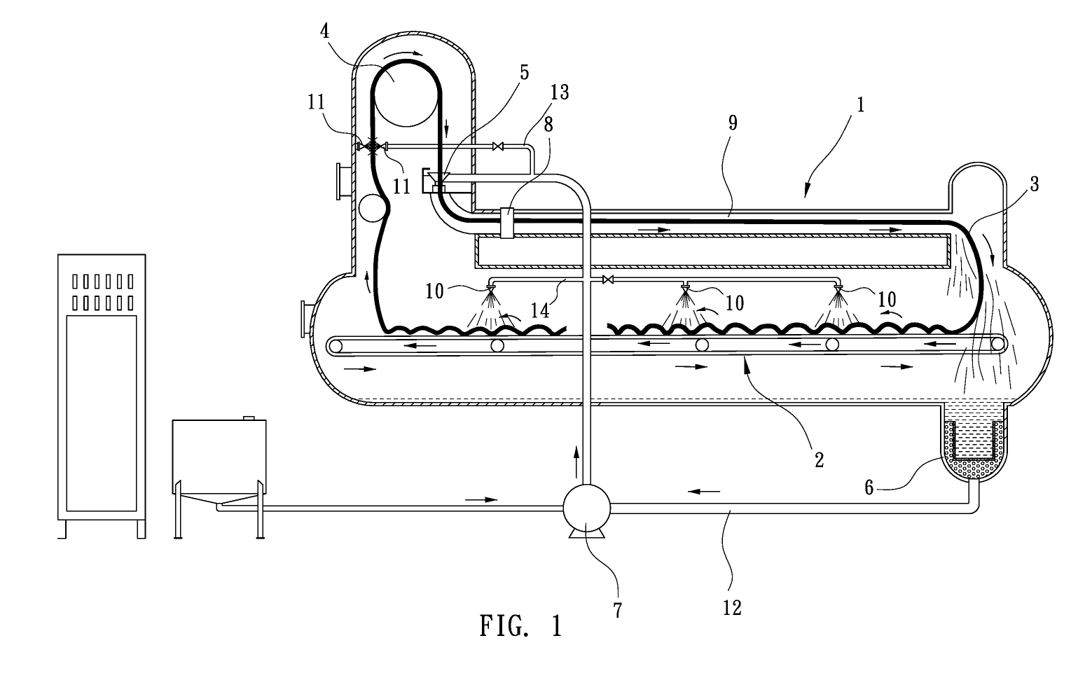

As shown in FIG. 1, the present invention provides a conveyor-driven fabric dyeing machine that comprises a fabric infiltration and rinse device. The fabric dyeing machine comprises a machine body 1 and a dyeing tube 9 is arranged above the machine body 1 to allow fabric to move therethrough. The dyeing tube 9 is provided therein with a fabric seam detectors 8 that is set at a predetermined location to detect a leading edger or seam of the fabric. A conveyor device 2 is arranged in the machine body 1. The machine body 1 is provided, in an interior space thereof, with a nozzle 5 and a fabric guide roller 4 arranged at an upper portion of a front end thereof. The machine body 1 is provided with a liquid storage tank 6 that is mounted to a bottom thereof. The liquid storage tank 6 is connected through a main pipe 12 to a pump 7. The pump 7 is connected through pipes 13, 14 to multiple spraying device 10, 11 so that a pressurized dye liquid or clear water supplied from the pump 7 can be jetted and sprayed, through the spraying devices 10, 11, onto fabric 3 that is carried on and driven by the conveyor 2 to circulate and cyclically move around the machine body in order to increase a degree of moistening of the fabric 3 and also to remove minute cotton pieces and chips and also residues of dyeing-assisting chemicals and, in addition, spraying can be made with the spraying devices 10, 11 onto an interior space of the machine body 1 to wash and remove contaminants present in the interior or attached to and stick to an interior surface of the machine body.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An infiltration and rinse device used in combination with a conveyor-driven fabric dyeing machine, the dyeing machine comprising a machine body in which a conveyor device is mounted for carrying and conveying fabric, the infiltration and rinse device comprising one or multiple spraying devices that have an end connected to an outlet terminal of a pump in order to receive and jet and spray a pressurized dye liquid or clear water supplied from the pump onto the fabric carried on and cyclically moved by the conveyor to moisten the fabric and rinse off impurities or contaminants attached to the fabric.

2. The infiltration and rinse device according to claim 1, wherein the spraying device is operable to cause spraying onto an interior of the machine body to wash and remove contaminants present in the interior of the machine body.
